(19) United States
(12) Patent Application Publication
(10) Pub. No.: US 2016/0050722 A1
(43) Pub. Date: Feb. 18, 2016

(54) Waveguide Exposure Chamber for a Micrwave Energy Applicator

(71) Applicants: Dimitri STAMATIOU, Orland Park, IL (US); LBP Manufacturing LLC, Cicero, IL (US)

(72) Inventors: Thomas FU, Naperville, IL (US); Dimitri STAMATIOU, Orland Park, IL (US); Steve WASZKOWIAK, St. Charles, IL (US); David MCLEAN, East Corrimal (AU)

(21) Appl. No.: 14/826,823

(22) Filed: Aug. 14, 2015

Related U.S. Application Data
(60) Provisional application No. 62/037,355, filed on Aug. 14, 2014.

(51) Int. Cl. H05B 6/68; H05B 6/80; H05B 6/78; H05B 6/64; H05B 6/70

(52) U.S. Cl. CPC H05B 6/68; H05B 6/6402; H05B 6/6455; H05B 6/708; H05B 6/78; H05B 6/80

(57) ABSTRACT

A microwave heating device for activating a microwave-activatable foam insulating material within the dual sidewalls of a beverage cup. The device has a waveguide that defines an exposure chamber for the articles. The waveguide has a plurality of 90-degree twisted rectangular sections, for rotating a perpendicular microwave field pattern along the length of the waveguide. A continuous flexible belt made of a dielectric material passes into and through the exposure chamber along a conveying path, and is formed and maintained into a curled shape in cross section through the exposure chamber to retain the untreated beverage cup upon the curled belt.

### CROSS-REFERENCE TO RELATED APPLICATION

This application claims the benefit of co-pending U.S. Provisional Application No. 62/037,355, filed Aug. 14, 2014, the disclosure of which is incorporated by reference in its entirety.

### BACKGROUND OF THE INVENTION

The invention relates generally to a microwave energy applicator and, more particularly, to waveguide applicators forming exposure chambers through which materials are conveyed and subjected to uniform microwave application.

In many continuous-flow microwave ovens, a planar product or a planar bed of material passes through a waveguide applicator concurrently or countercurrently to the direction of wave propagation. These ovens are typically operated in either single or multimode configurations. Single mode applicators have the advantage of a very clearly defined field pattern. For example the TE10 mode provides a peak in the heating profile across the width of the waveguide applicator, midway between its top and bottom walls, at product level. This type of applicator can make it simpler for some planar products to achieve relatively heating of the product.

Planar articles or products such as a sheet of material having a microwave-activated material can be passed through a microwave oven to activate the microwave-activatable material, and then a finished article or product can be assembled from the sheet substrate with the applied microwave-activated material thereon. An example of such an apparatus and method for making paperboard beverage containers are described in US 2012/0048450, the disclosure of which is incorporated by reference in its entirety. Other examples of industrial microwave ovens and their uses are disclosed in U.S. Pat. No. 7,470,876, issued to Drozd et al on Dec. 30, 2008, U.S. Pat. No. 7,002,122, issued to Eves, II et al on Feb. 21, 2006, U.S. Pat. No. 7,026,588, issued to Delmotte et al on Apr. 11, 2006, and U.S. Pat. No. 5,834,744, issued to Risman on Nov. 10, 1998, the disclosures of which are incorporated by reference in their entireties. Such systems do not provide uniform heating of an article that has a three-dimensional profile such as a cylindrical or conical structure.

Therefore, there remains a need for a continuous-flow microwave oven capable of uniform application of microwave energy to a three-dimension structure, and in particular, to a three-dimension cylindrical or conical structure that contains a microwave-activatable material.

### SUMMARY OF THE INVENTION

The present invention provides an industrial microwave heating device that includes a waveguide that comprises an exposure chamber that extends in the direction of microwave propagation from a first end to a second end. The microwave heating device also includes a source of microwave energy for generating the microwaves that propagate through the waveguide. A first and second port is provided in the waveguide for allowing a conveyancing means to enter and exit the waveguide. A conveyancing means passes through the exposure chamber along a conveying path in the direction of wave propagation, with the means entering through the first port and exiting out the second port.

The device also includes a staging means for de-accelerating and positioning an article to be microwave\ heated onto the conveyancing means. In one embodiment, the staging means is permanently attached to the waveguide and in another embodiment, the staging means is transportable such that it can be positioned in association with the conveyancing means. In one embodiment of the conveyancing means, the means is flexible belt that can be formed into a curled shape in cross section, typically prior to the belt entering the exposure chamber. A plurality of identical belt supports, each having an arcuate shape in cross section, are disposed within and along the exposure chamber, each with a support surface that supports the curled belt. In another embodiment of the conveyancing means, the belt is a plastic linked belt that includes positioning side panels.

In an aspect of the invention, the waveguide comprises one or more axially-twisted rectangular waveguide sections for rotating the perpendicular microwave electric field (E-field) pattern along the length of the exposure chamber.

In another aspect of the invention, the waveguide comprises one or more rectangular waveguide sections each having a pair of metallic deflectors for guiding or distorting the propagating microwave E-field into a modified pattern that improves the uniformity of exposure of the conveyed articles to the microwave energy.

In yet another aspect of the invention, the microwave heating device comprises an upper waveguide chamber having a rectangular cross section through which the microwaves are propagated, and a lower exposure chamber. The upper waveguide chamber and the exposure chamber are separated by an elongated plate having a plurality of longitudinally-formed slots extending therethrough for passing microwave energy from the upper waveguide chamber to the exposure chamber. The slots can be spaced along both sides of the centerline in a staggered arrangement, with the spacing between the centerlines of the slots being a distance of about one-half a waveguide wavelength (λ) of the electromagnetic wave supplied by the microwave source. The spacing distance is about 6.45 inches for microwaves of 915 MHz, and about 2.45 inches for microwaves of 2.45 GHz. The row(s) of slots are spaced about one-third the distance from the centerline to the respective sidewall.

The present invention further provides a method for making an article having a microwave-activatable material in the industrial microwave heating device of the invention, comprising the steps of: i) providing a plurality of untreated container cups having a microwave-activatable material, and which include an upper rim that defines the top opening of the cup; ii) delivering the untreated container cups to a continuous conveying means having an upper surface; iii) passing the conveying means and the untreated container cups disposed thereon into and through a waveguide of the industrial microwave heating device; iv) propagating microwaves through the waveguide to activate the microwave-activatable material with microwave energy to form treated container cups; v) passing the conveying means and the treated container cups out from the waveguide; and vi) releasing the treated container cups from the conveying means.

The present invention also provides a method for controlling the microwave activation of a microwave-activatable material comprised in an article in an industrial microwave heating device that includes a microwave energy source and an exposure chamber, comprising the steps of: i) determining the number of articles disposed within the exposure chamber of the heating device over a period of time; ii) measuring the temperature of one or more surfaces of a treated article exiting the heating device during the period of time; iii) comparing the measured temperature against a target temperature for a treated article; and iv) controlling the energy output of the microwave energy source as a function of the comparison of the measured temperature and the target temperature, and of the number of articles disposed within the exposure chamber.

### BRIEF DESCRIPTION OF THE DRAWINGS

These features and aspects of the invention, as well as its advantages, are better understood by reference to the following description, appended claims, and accompanying drawings, in which:

FIG. 1 is a perspective view of a first embodiment of a microwave heating device of the invention, including a waveguide exposure chamber having a plurality of twisted waveguide sections, with one embodiment of a conveying means in the form of a belt conveyor for carrying an article which contains a microwave-activatable material through the waveguide exposure chamber.

FIG. 2 is a perspective view of a first embodiment of an article staging section which includes a means for curling the conveying belt that carries the article.

FIG. 3 is detailed view of the FIG. 2 means for curling the conveying belt.

FIG. 4 is a perspective view of a belt conveying means and a plurality of belt supports for carrying the articles through the length of the exposure chamber; the structure of the waveguide is removed to improve the illustration.

FIG. 5A is cross-sectional view of the microwave heating device of FIG. 1 taken along lines 5A-5A.

FIG. 5B is cross-sectional view of the microwave heating device of FIG. 1 taken along lines 5B-5B.

FIG. 6 is a perspective view of the exit end of the microwave heating device showing systems for detecting the pitch and temperature of the treated articles exiting the device.

FIG. 7 is perspective view of another embodiment of a microwave heating device with a linear waveguide exposure chamber.

FIG. 8 is a cross-sectional view through the microwave heating device of FIG. 7 along lines 8-8, showing metallic microwave guides for influencing the microwave energy pattern through the exposure chamber.

FIG. 9 is an illustration of the microwave energy pattern within a rectangular section of an exposure chamber when the microwave guides are not provided.

FIG. 10 is an illustration of the microwave energy pattern within a rectangular section of an exposure chamber that includes the metallic microwave guides.

FIG. 11 is a partially-sectioned, perspective view of yet another embodiment of microwave heating device of the invention, including an upper waveguide and a lower exposure chamber, viewed along line 11-11 of FIG. 12.

FIG. 12 is a sectional view of the microwave heating device of FIG. 11 taken through line 12-12 of FIG. 11.

FIG. 13 is a perspective view of another embodiment of a belt conveyor, showing a portion of a plastic linked belt having side positioning panels.

FIG. 14A is perspective view of a second embodiment of a staging system of the microwave heating device of FIG. 1, this staging system being removably transportable from association with the waveguide.

FIG. 14B is a perspective view of the removably transportable staging system of FIG. 14A, removed from association with the waveguide of microwave heating device.

### DETAILED DESCRIPTION OF THE INVENTION

Definitions

As used herein, the phrase “microwave-activatable” means curable, expandable, heatable or action taken by a material or a composition when exposed to microwave energy.

As used herein, the term “vertical” is a direction oriented in the “y” direction as illustrated in the Figures, unless otherwise indicated.

As used herein, the term “lateral” is a direction oriented in the “z” direction as illustrated in the Figures, unless otherwise indicated.

As used herein, the term “longitudinal” is a direction oriented in the “x” direction as illustrated in the Figures, unless otherwise indicated.

As used herein, the term “horizontal” is a direction oriented in the x-z plane.

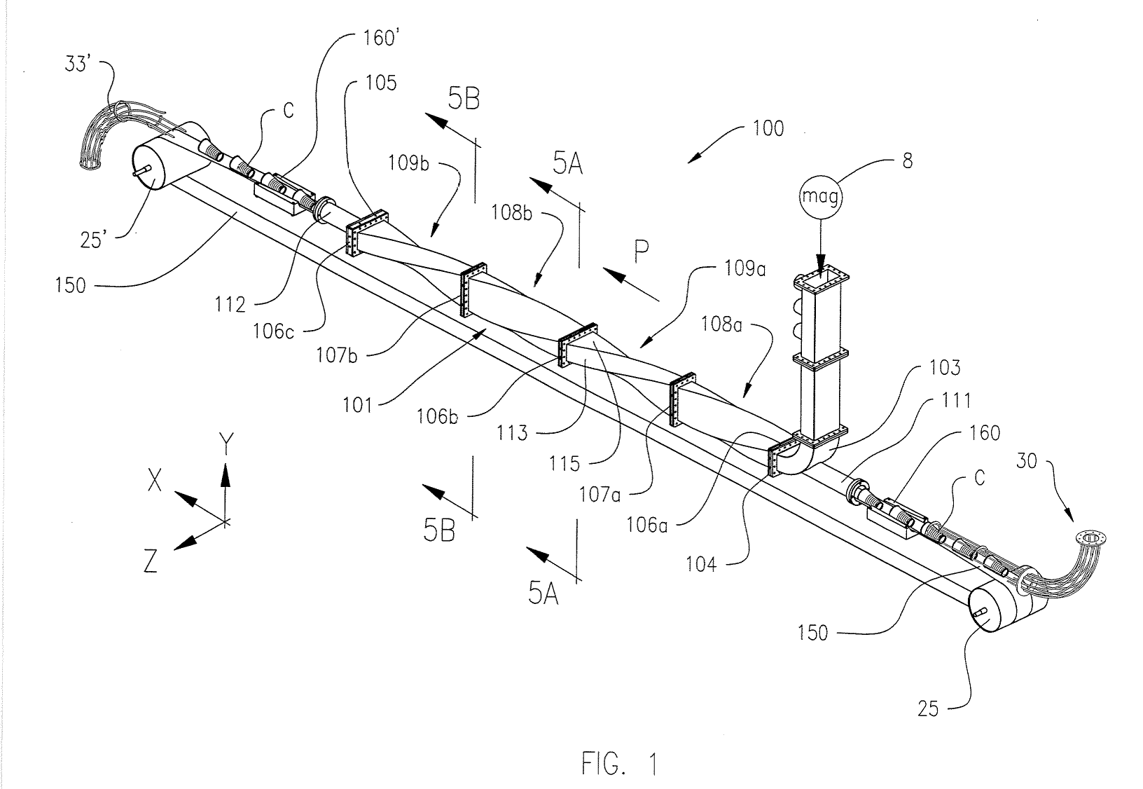

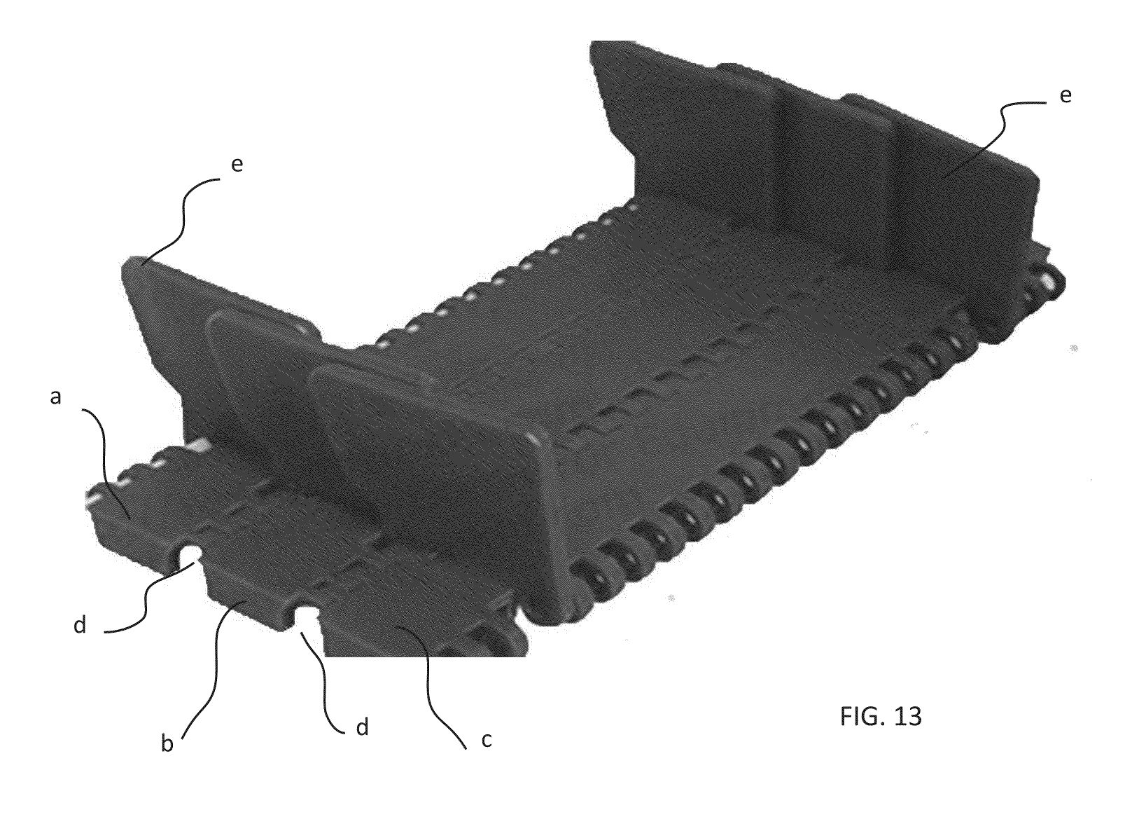

A first embodiment of an industrial microwave heating device 100 embodying features of the invention is shown in FIGS. 1 through 5B. FIG. 1 shows the heating device includes a waveguide 101 comprised of a bend segment 103 and one or more waveguide sections 108a, 109a, 108b, 109b that are generally rectangular in cross section. (“Rectangular waveguide” is used in a broad sense to encompass waveguides that may not be perfect four-sided geometric rectangles, but that have a number of corners in cross section as opposed to circular or elliptical waveguides whose cross sections do not have corners.) A portion of the waveguide forms an exposure chamber 102 through which a material or article to be heated with microwave energy is conveyed therethrough. In this embodiment, the waveguide exposure chamber 102 has a first end shown at 104 in close association with the bend segment 103 and a second end shown at 105. The conveyance of article through the exposure chamber 102 can be accomplished through the implementation of a number of different types of conveyancing means. For example, an air-assist conveyancing system as well as various types of belt and chain conveyor systems could be employed. One type of a belt and a chain conveyor system will be described herein and the present invention should not be considered to be limited to only those two types of conveyancing systems, FIG. 1 shows a first embodiment of a conveyancing means in the form of a belt conveyor 150, while FIG. 13 shows a chain conveyancing means, each of which will be described in greater detail later herein.

The heating device of the invention also includes a microwave energy source 8 such as a magnetron, supplies microwave energy to the exposure chamber 102 through a waveguide bend segment 103. Microwave energy then propagates through the exposure chamber 102 in a direction of propagation, represented by arrow P, from exposure chamber first end 104 to opposite, second end 105. The conveyor belt 150 advances along a conveying path that enters and exits the exposure chamber 102 and this path may follow the direction of propagation P or it may travel opposite to the direction of propagation. As seen in FIG. 1, conveyor belt 150 first advances into and through entrance port 111 in the curved waveguide bend segment 103, which marks the entrance to the waveguide 101. The belt then travels through exposure chamber 102, exiting waveguide 101 at exit port 112. The belt 150 carries the materials or articles to be heated through a microwave exposure region within the exposure chamber 102 between the two ports 111, 112. The microwave exposure region is generally the volume that the material occupies within the exposure chamber, along an axis through the entrance and exit ports. The entrance and exit ports 111, 112 provide the entrance and exit openings, respectively, for passing the conveyancing means through the exposure chamber 102, along a concurrent or counter-current conveying path to the direction of wave propagation. The cylindrical entrance and exit ports 111, 112 also operate as chokes that function as high pass filters to block and prevent microwave energy from passing out of the waveguide 101. The cross-sectional diameter and length of the entrance port and exit ports are identical and sufficiently dimensioned to allow the passage therethrough of the conveyancing means and the materials or articles being carried, but sufficiently dimensioned to block and prevent the microwave energy from escaping therethrough. In the example shown in FIG. 1, the entrance and exit ports 111, 112, are shown to be sized in cross-section to allow the entry of a cup article that will be heated within the exposure chamber 102.

The waveguide exposure chamber 102 can comprise at least two individual 90-degree twisted rectangular waveguide sections and may include three or more waveguide sections. In an application where a cylindrical or conical article like a cup is to be heated within the heating device, three waveguide sections will accomplish uniform microwave energy exposure but it is preferred to provide at least four waveguide sections to ensure uniform exposure in the event that a portion of the article is not exposed to any part of the microwave energy profile. Each waveguide section has what is considered to be a horizontal end and a vertical end, A 90-degree twisted rectangular waveguide section is described in U.S. Pat. No. 3,843,860, issued to Jory et al on Oct. 22, 1974, and in U.S. Pat. No. 3,715,551, issued to Peterson on Feb. 6, 1973, the disclosures of which are incorporated by reference in their entireties. The waveguide 101 shown in FIG. 1 comprises four 90-degree twisted rectangular waveguide sections. A first 90-degree twist waveguide section 108a is connected to the output of the waveguide bend segment 103 through a first horizontally-arranged rectangular union 106a, and twists 90 degrees counter-clockwise (though each waveguide section could twist clockwise) along its length to a first vertically-arranged rectangular union 107a, where it joins the inlet end of a second 90-degree twist waveguide section 109a. The second 90-degree twist waveguide section 109a twists 90 degrees along its length to a second horizontally-arranged rectangular union 106b, where it joins the inlet end of a third 90-degree twist waveguide section 108b. The third 90-degree twist waveguide section 108b twists 90 degrees along its length to a second vertically-arranged rectangular union 107b, where it joins the inlet end of a fourth 90-degree twist waveguide section 109b. The fourth 90-degree twist waveguide section 109b twists 90 degrees along its length to a third horizontally-arranged rectangular union 106c, at exit end 105 of the exposure chamber 102. The 90-degree twist waveguide sections 108a, b and 109a, b are identical structures, differing only in their orientation of twist and whether a respective inlet and exit terminates with either a horizontal or vertical connecting flange. An optional fifth 90-degree twist section can also be used. The four waveguide sections that form twisted rectangular waveguide 102 are arranged to collectively rotate the perpendicular electric field pattern a full 360 degrees across the length of the four 90-degree waveguide sections, with each waveguide section rotating the energy field 90 degrees from the orientation of the energy field that first entered that respective waveguide section. A 360 degree rotation will expose with a more uniform heating and curing of the article(s) being conveyed by the entire circumference of the cylindrical article, or cup, to the same energy profile, thereby resulting the belt 150. Preferably with cylindrically shaped articles, an even number of 90-degree waveguide sections are used so that the entire surface area of the object is exposed to equal amounts and durations of high and low energy fields along the length of the exposure chamber 102.

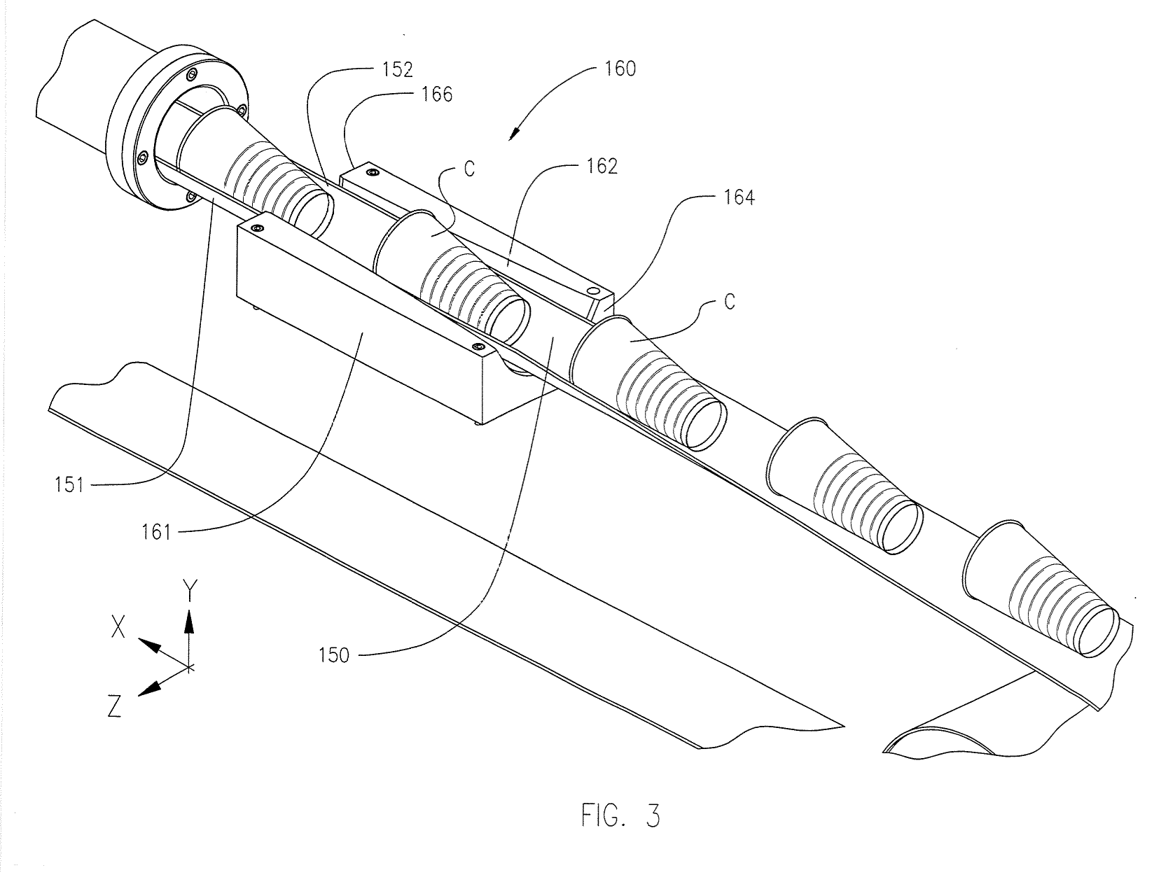

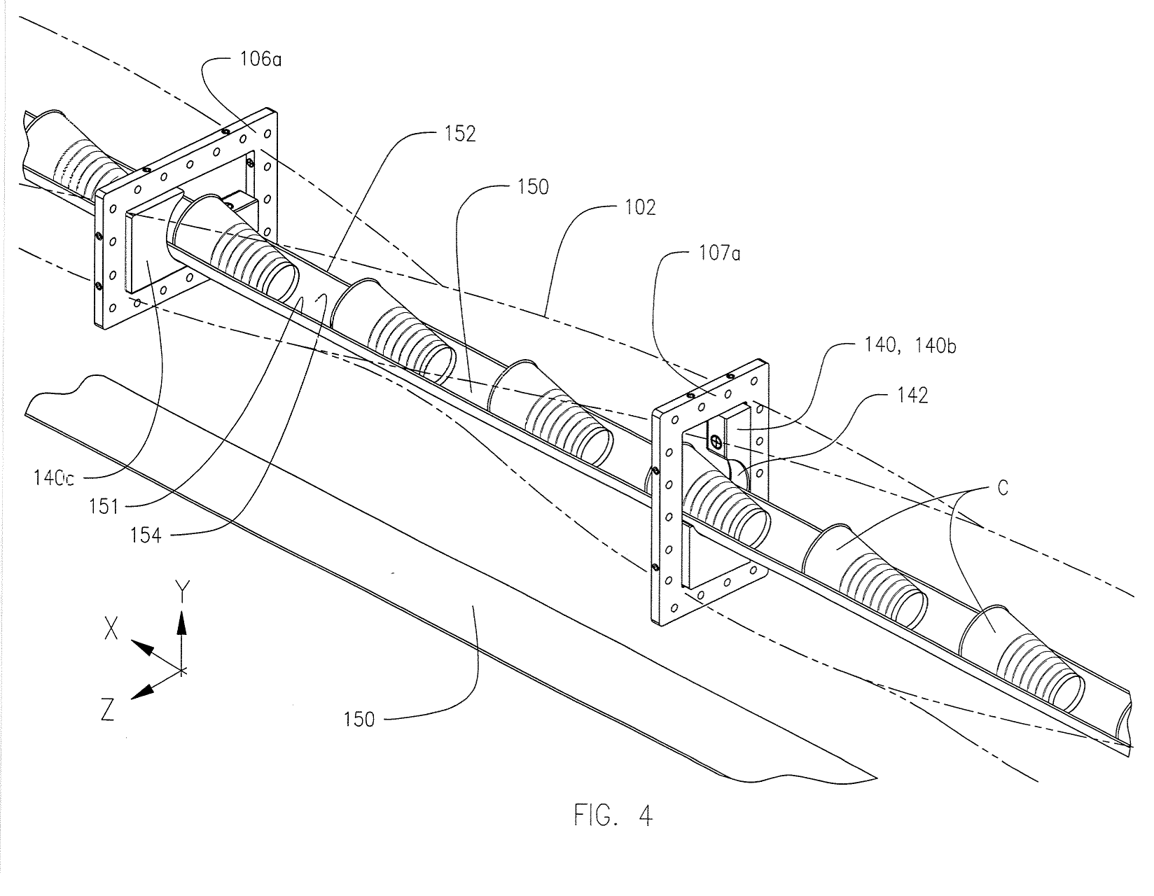

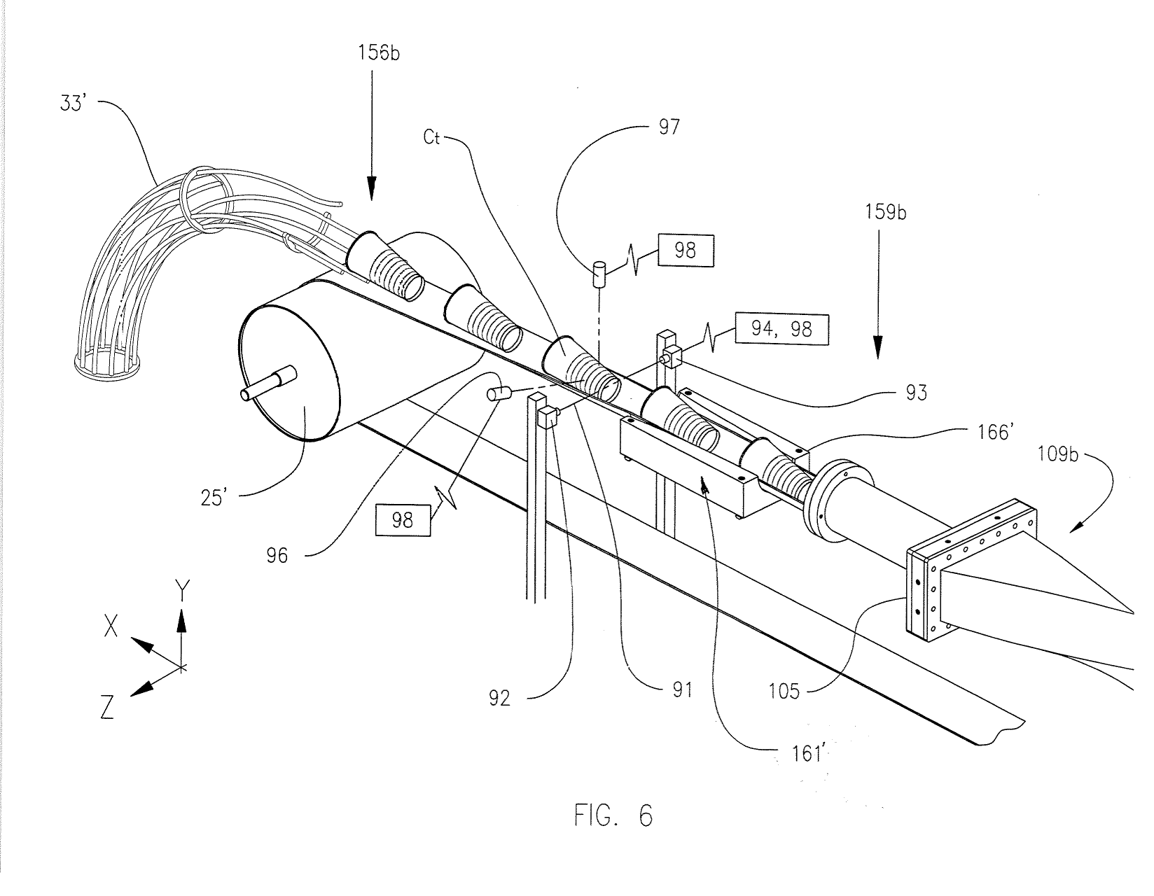

In a first version of the conveyancing means, the conveying belt 150 as shown in FIG. 3, is a continuous flexible, planar belt supported by belt pulley 25 and is formed into a curled shape having an arcuate cross-sectional profile prior to entering the cylindrical entrance port 111, and is maintained in the curled shape as the belt passes through the exposure chamber 102 and out through the exit port 112, being supported by belt pulley 25′, as shown in FIG. 6. FIG. 4 shows a plurality of belt supports 140 disposed within and intermittently spaced along the exposure chamber 102 to support the weight of the belt 150 and assist in maintaining the arcuate, curled shape of the belt 150 as it passes through the exposure chamber 102. The belt supports 140 also form a part of the belt conveyance means. The continuous belt 150 is drawn under tension through the heating device by each of the belt pulleys 25, 25′, as shown in FIG. 1. Under typical operating conditions, the belt moves along at constant linear speed, and usually between 10-50 feet per second. The conveying 150 can be made of a microwave-transmissive material or a dielectric material, which do not interfere, distort, or block the transmission of microwaves therethrough. A typical dielectric material and belt construction includes a polytetrafluoroethylene (PTFE) coated fiber glass belt, an ultra-high molecular weight polyethylene (UHMWPE) belt, a polysulfone coated glass fabric belt, a polypropylene belt, and a polypropylene coated glass fabric belt.

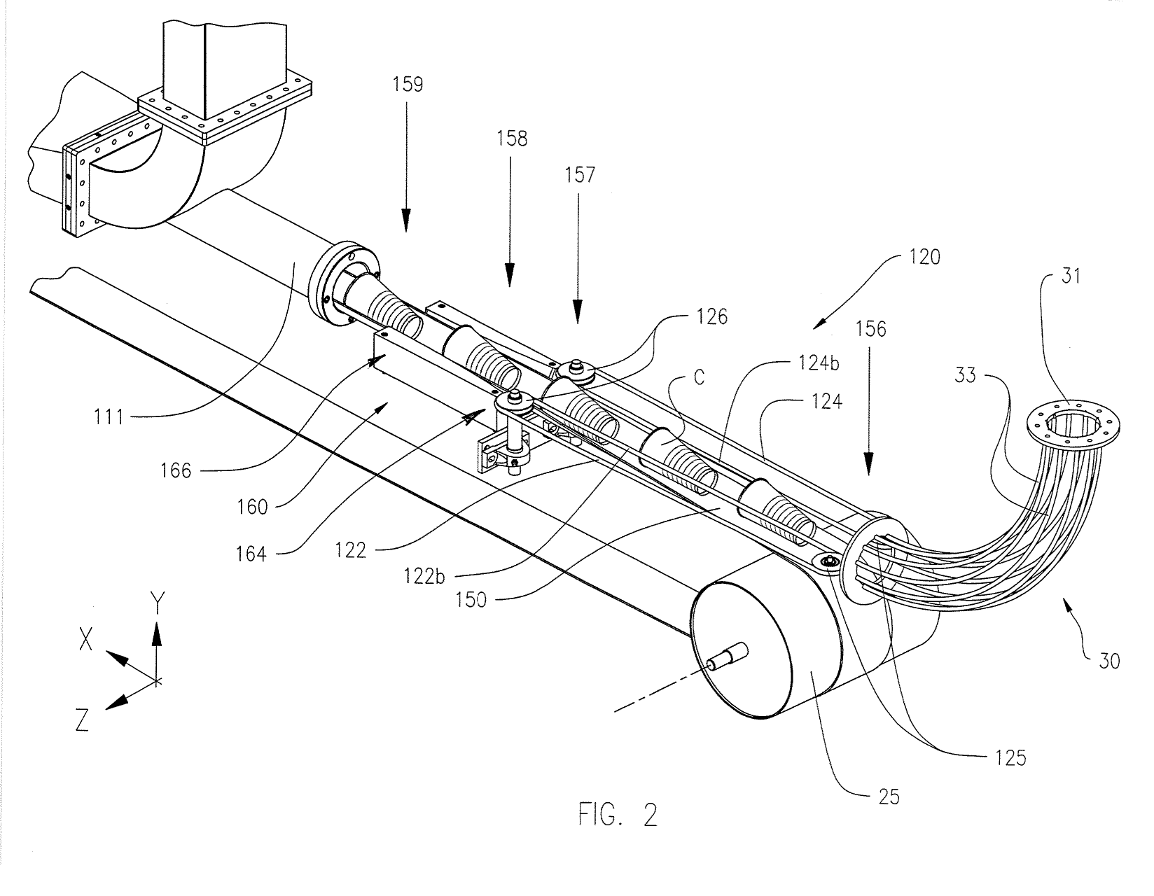

The heating device 100 also includes a belt curling means 160 for forming the belt 150 into a curled shape, which is arcuate in cross section, prior to the belt 150 entering the exposure chamber 102. A means for forming the belt 150 into a curled shape is shown in FIGS. 2 and 3, illustrated as a forming block 161 having a trough 162 oriented in the travel direction of the belt 150. The trough 162 has an arcuate surface that guides the shaping of the curled belt. The radius of the arcuate surface is continuously reduced or tapered from a first or wider end 164, to a second or tapered end 166 of the forming block. As shown in FIG. 2, the belt 150 departs from the belt pulley 25 in a substantially planar form, and transitions from the planar shape at point 156 at the pulley 25 to a partially-curled shape at point 158 at the wider, inlet end 164 of the trough 162. The forming block 161 is oriented with a narrower, tapered outlet end 166 facing toward the entrance port 111 of the waveguide 101. The arcuate shape of the outlet end 166 of the trough 162 can define a circular are of at least 120° in the cross-sectional profile of the belt, and typically up to about 180°, and in some embodiments, to greater than 180°. The arcuate shape of the belt is maintained along the entire travel pathway through the exposure chamber by appropriate adjustment of the tension on the belt 150 at pulleys 25 and 25′ and by placement of intermittent belt supports.

As the belt 150 advances along the trough 162, the radius of the trough 162 decreases from the wider end 164 to the tapered end 166, causing the belt 150 to curl progressively into a circular or curled shape of smaller radius. In a typical application, the linear speed of the belt can be 10-50 feet per second through the airspace of the waveguide, which can impart air turbulence forces upon an article carried along upon the belt. In an application of the invention where the article is a cylindrical- or conical-shaped beverage container having a circular rim and bottom, the formed curled belt 150 at point 159 inhibits or prevents the beverage container from rolling laterally when the air forces act upon the article, thereby retaining the orientation and position of the beverage container upon the belt as the curled belt proceeds into the entrance port 111 and through the exposure chamber 102. The curling of the belt 150 also creates a contact friction between the rim of the beverage container and the surface of the belt 150, which inhibits or prevents axial movement of the beverage container in a direction along the length of the belt. The holding of the article in a stationary position upon the moving belt can significantly improve the quality and reliability of the heating process.

The heating device also includes a belt un-curling means 160′ near the exiting end 105 of the exposure chamber 102 that maintains the fully curled belt 150 in its curled shape during the transit through and exiting from the waveguide, but which also uncurls the belt 150 after that portion of the belt 150 has exited the waveguide 101, shown in FIG. 6. An un-curling means 160′ comprises a second forming block 161′ that is identical to the forming block 161 at the entrance to the waveguide, but is reversed so that the narrower, tapered end 166′ is oriented toward the exiting port 112 of the waveguide 101. The tapered end 166′ of the exiting forming block 161′ cooperates with the narrower, tapered end 166 of the entrance forming block 160 to maintain the fully curled shape of the belt 150 through the entire length of the exposure chamber 102. The belt 150 exiting the waveguide 102 transitions along the forming block 161′ from a fully curled shape, then to a semi-curled shape at end 164′, and then back into a fully planar shape at point 156b as the belt encounters exit pulley 25′.

Alternative means for forming the belt 150 into a curled shape, and for uncurling the belt, can include curling finger rings with gradually smaller radius for the entrance and the reverse for the exit, or a series of laterally-extending progressively-curved rollers. Those in the art would understand either of these curling and de-curling alternatives, therefore, they are not shown or described in the drawing figures.

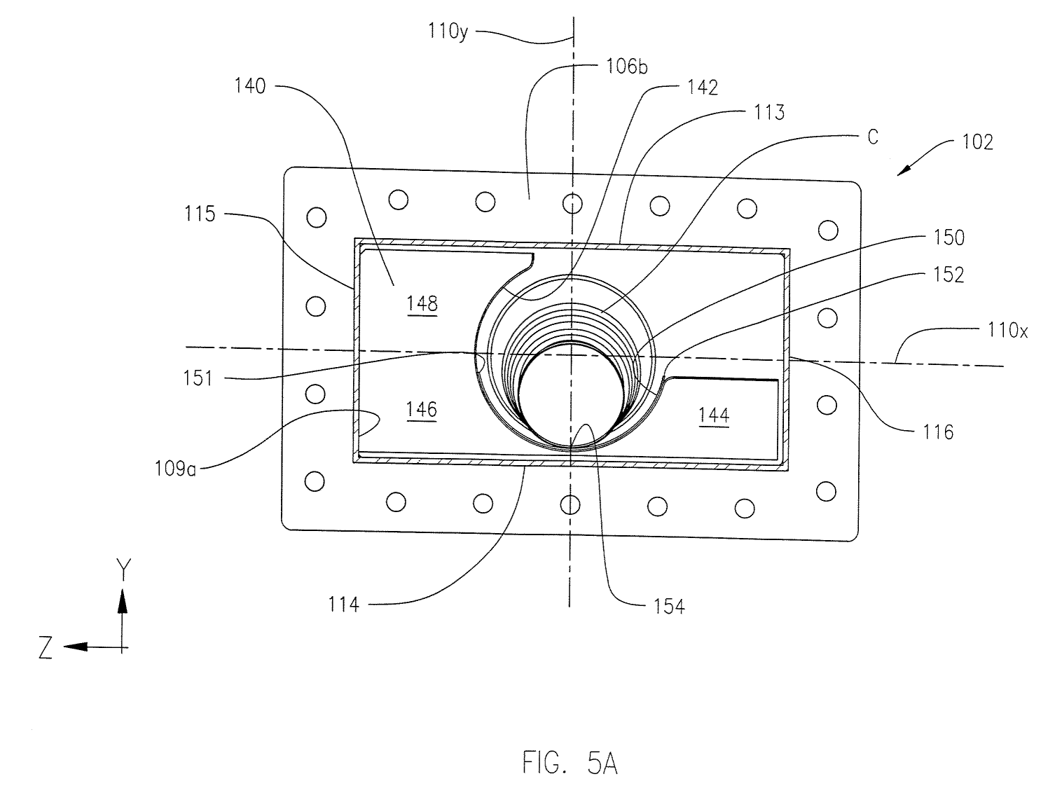

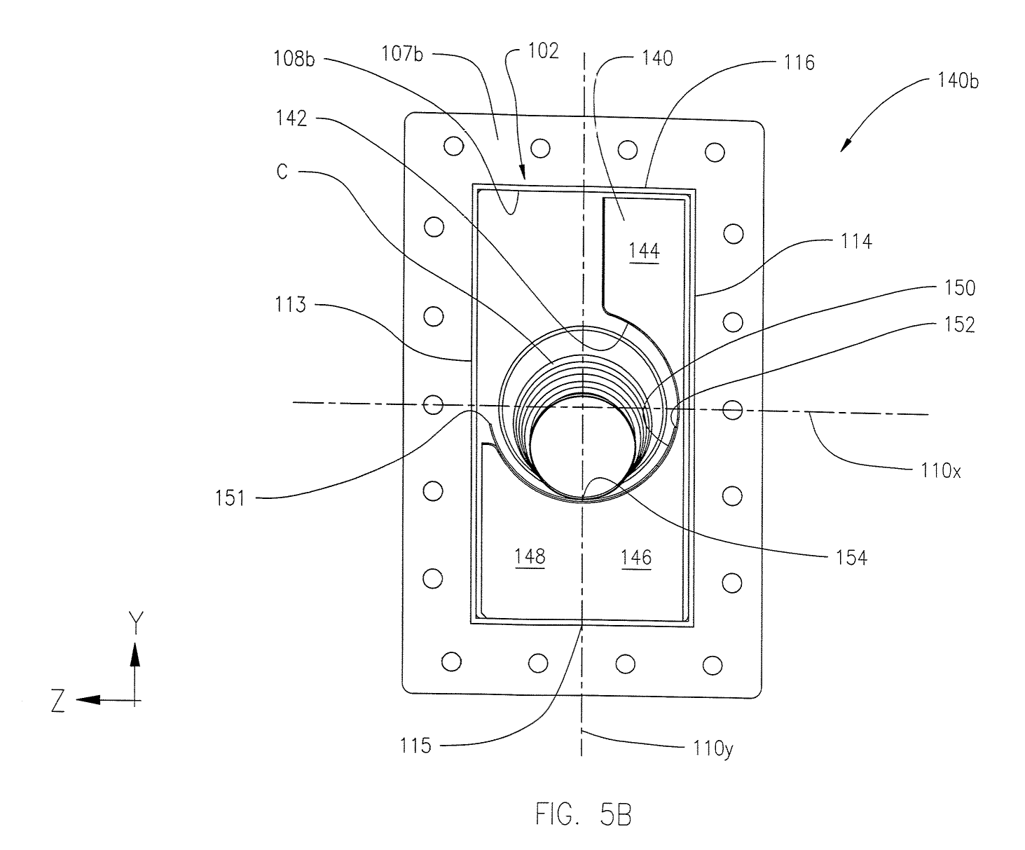

FIG. 4 shows another component of the belt conveyancing means. There, it is seen that the belt 150 passes through and is supported by belt supports 140a, 140b positioned intermittently along the length of the twisted exposure chamber 102 (shown in dotted lines to emphasize the features of the belt and supports). Each belt support 140a,140b includes an arcuate support surface 142 formed into an arc sufficient to support the full width of the curled belt 150 at its center portion 154 and the lateral edges 151 and 152. In the illustrated embodiment, it is seen that a belt support 140 is located at the transition of each of the 90-degree twisted rectangular waveguide sections, and is configured with an arcuate support surface 142 of about 270 degrees, sufficient to provide support in either its horizontal rectangular orientation shown in FIG. 5A (including supports 140a used at the end of the first 90-degree section 108a, between the second and third 90-degree sections 109a and 108b, and at the exit end of the fourth 90-degree section 109b), or its vertical rectangular orientation shown in FIG. 5B (including supports 140b used between the first and second 90-degree sections 108a and 109a, and between the third and fourth 90-degree sections 108b and 109b). As seen in FIGS. 5A and 5B, each belt support 140a, 140b includes integral quarter portions 144, 146 and 148. In the horizontal, rectangular orientation shown in FIG. 5A, first portion and second portion 144, 146, collectively define an arcuately shaped or curved surface which is about 180 degrees. Quarter portion 148, is integral with quarter portion 146, and these two portions collectively form a second part of the belt support surface, which define an arcuately shaped or curved surface which also is about 180 degrees. The quarter portions 144, 146, 148 shown in FIG. 5B are also integrally joined together and are formed with the same arcuately shaped surfaces as those described in FIG. 5A, except the orientation of the belt support itself 140, is vertical rather than horizontal. In all respects, each belt support 140 is identical to the other regardless of its orientation within the waveguide 101.

The belt supports 140 can be made of a microwave-transmissive material or a dielectric material that does not interfere or block the transmission of microwaves therethrough. The belt supports 140 include, or can be configured for insertion into, an outer flange 106, 107 with bolt holes for insertion between and fastening to the flanges of the 90-degree twisted rectangular waveguide sections.

FIG. 5A also shows the transverse sectional view of the exposure chamber 102 through the horizontal rectangular exit of 90-degree section 109a, looking toward the union 106b and the inlet of the succeeding 90 degree section 108b. The exposure chamber extends between the opposed longer sidewalls 113, 114 and the opposed shorter sidewalls 115, 116. The shape and dimensions of the exposure chamber section propagate microwaves from the entrance end to the outlet end with minimal degradation and interference. The generally rectangular cross section of the exposure chamber 102 is dimensioned to support TE10 electromagnetic waves and excluding those with modes above TE10. The width of the waveguide between opposed sidewalls 115, 116 is preferably greater than or equal to half the wavelength (λ) and less than 1 wavelength of the electromagnetic wave supplied by the microwave source. The height of the exposure chamber between opposite sidewalls 113, 114 is preferably less than half the wavelength of the electromagnetic wave only to support TE10 wave modes. FIG. 5B shows a transverse sectional view of the exposure chamber 102 through the vertical rectangular exit of 90-degree section 108b, looking toward the union 107b and the inlet of the succeeding 90 degree section 109b.

A plurality of articles that include a microwave-activatable material are passed through the waveguide and exposed to the microwave energy. The articles typically have a cylindrical or conical shape, such that the article can roll along a periphery edge in a lateral direction upon a flat surface. When disposed upon the curled belt 150, lateral rolling movement of the article is inhibited or prevented. A non-limiting example of this type of an article is a paperboard beverage container “C” having a continuous sidewall that includes a uniform layer or spaced lines of a composition comprising a microwave-expandable material that is applied upon an internal surface of the sidewall (not shown). Exposure of the microwave-expandable material to a uniform field of microwave energy produces a uniformly-expanded material that can provide, inter alia, thermal insulative properties to the container.

A second embodiment of a conveyancing means is shown in FIG. 13, where only a section of a plastic linked belt is presented. A plastic linked belt can be substituted in place of the fiber glass belt described above as long as the plastic material is microwave transmissible. As seen, links “a”, “b”, and “c” are joined together to form a flexible and continuous belt that would extend through the waveguide in a similar fashion to that of the fiberglass belt. With a plastic linked belt, driven pulleys 25 and 25′ would have to include respective sprockets (not shown) on each pulley end that would align with and engage with the series of slots “d” that are formed in the plastic link belt when a multiplicity of links are joined together to form a continuous belt. It should be readily understood by those in the art how the teeth of each sprocket would interface with the slots to drive the plastic linked belt through the waveguide. Therefore, the sprockets are not shown in the drawings. The plastic belt also includes identical and repositionable side positioning panels “e” that attach to the links. These panels laterally contain an article on the belt to prevent its lateral movement while the belt travels.

FIG. 2 shows a first embodiment of an integral article staging system 30 for de-accelerating and depositing a unit of an untreated or non-microwaved article onto the belt 150 at the entrance end of the waveguide 102. In an example of the invention, the untreated article is a paper beverage container having a frusticonical sidewall and closed bottom, and which includes a microwave-activatable material. The article staging system 30 includes guiderails 33 that receive the containers from a pressurized, pneumatic transfer system at an in-feed end 31, and deposit the article onto the belt 150 at or between points 156 and 157. The open spaces in the guiderails 33 allow the conveying air to escape and the containers to loose velocity, thereby slowing the speed of the container. The containers can be conveyed to the article staging system 30 by other known conveying systems, including mechanical belt and gravitation conveyance. The containers can be delivered substantially continuously at a predetermined pitch (that is, timing between successive container deliveries) to the belt 150 between the in-feed belt pulley 25 and the belt forming means 160. The containers C are oriented with their openings facing forward. A pair of side rails can be employed to maintain the position of the deposited containers in the lateral center of the belt 150 as it approaches the belt forming means 160. The belt 150 with the intermittently-disposed, untreated containers then passes through the belt forming means 160 to curl the belt in its lateral dimension into a curled belt at point 159, with the intermittently-disposed untreated containers C disposed thereon. After passing through the entrance choke 111, the intermittent-disposed, untreated containers C are passed through the length of the exposure chamber 102 and exposed to the microwave energy supplied therein. The duration of exposure within the exposure chamber 102 is typically constant from container to container, and based upon the pre-selected and constant linear speed of the belt 150. At the end of the exposure chamber, the treated containers moving along the curled belt 150 exit the exposure chamber through the exit choke 112, and drop through exit guiderails 33′ to a further processing system.

The article staging system also includes a speed-matching system that is also an integral component of the microwave heating device of the invention and this component can be used along the sides of the in-feed portion of the belt 150 to deaccelerate (or accelerate) the incoming untreated containers C to a speed that matches the linear speed of the belt 150. Matching the speed or velocity of the article to that of the belt prevents slippage of the incoming containers C relative to the belt and stabilizes the containers C in the proper position upon the belt surface. Matching also aids in controlling the pitch (interval and rate) of the containers C entering the exposure chamber 102. FIG. 2 shows a speed-matching device 120 including a pair of belts 122 and 124 disposed on the sides of the in-feed portion of the article staging system. The belts are driven between opposed pairs of driven pulleys 125, 126 in synchronized linear speed with the speed of the belt 150. The inside segments 122b, 124b of the belts 122, 124 can extend partially into the pathway of untreated container articles to slow down (or speed up) the untreated containers C. The belts are typically made of a polyurethane material and can be either planar or circular. The pair of belts also assist in positioning the center axes of the untreated containers C along the lateral center 154 of the belt 150 as they approach the belt forming means 160.

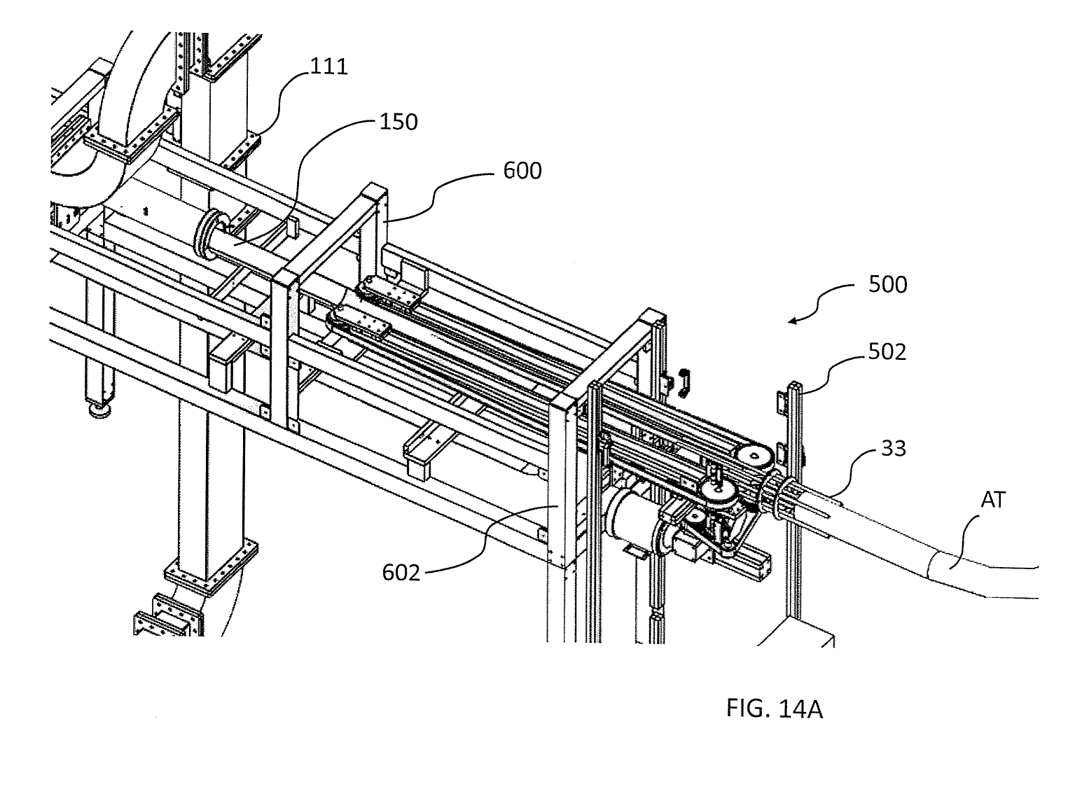

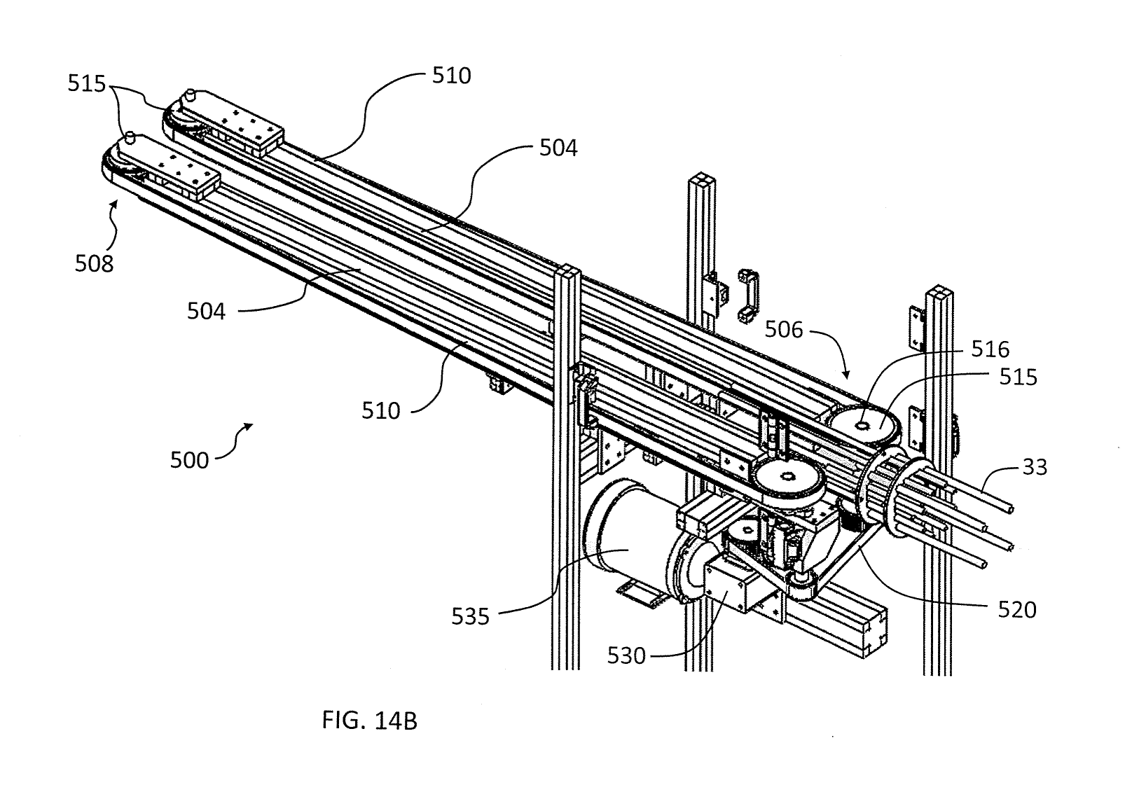

An alternative embodiment of a staging system is shown in FIGS. 14A and 14B. This staging system 500 is a stand-alone system that is not integrally formed as an attached component of the heating device but rather is movable and transportable such that it can be closely associated with and positioned near inlet port 111. This staging system 500 also functions as a combined positioning and de-accelerating system for de-accelerating and depositing a unit of an untreated or non-microwaved article (paper cup) onto the belt 150 or other conveyancing means at the entrance end of the waveguide 102. The article staging system 500 includes a four-post frame 502 that is provided with wheels (not shown) to facilitate transporting the system for use with other conveyancing systems that may require a staging system for its process. A part of the frame 502 has been removed from the drawing figures to facilitate viewing and clarity. A pair of identical arms 504 are attached to frame 502. Each arm has a respective and identical belt drive system attached thereto. Each belt drive system is comprised of a continuous flexible belt 510 that can either be planar or round. Each arm 504 also terminates with an identical pulley 515 attached at each end 506, 508. If a round belt is used, the pulleys 515 will be channeled, rather than flat. Each of the pulleys 515 at arm end 506 include a shaft 516 that extends downwardly such that they are driven by a lower belt drive 520. Belt drive 520 is connected to gearbox 530, which is connected to motor 535. Guiderails 33 that receive the containers from a pressurized, pneumatic transfer system AT, are disposed between the arms 504 and deposit the article onto the belt 150 at or near heating device framework 600. The drive pulley 25 for driving the conveyancing means, belt 150, is not seen in the drawings figures but would be present and positioned the area of the waveguide framework identified at 602. The open spaces in the guiderails 33 allow the pneumatic conveying air of system AT to escape so that the containers lose velocity prior to encountering the belts 504. Once an article is received between each of the belts 504, it is again de-accelerated by the speed of belts 504, which are matched to that of the conveyancing means 150. Each drive belt 504 is arranged to be turning in the same direction so that an article can be advanced along each arm. At end 508, each arm is intentionally arranged to be laterally displaced farther away from each other than at end 506. In this way, when the conveyed article reaches end 508, it will drop onto the conveyancing means 150 for further transport into the waveguide. The mobility of this staging system allows the pair of arms 504 to be precisely positioned over the conveyancing means 150 to ensure proper location of an article dropped thereupon. The extended length of each arm 504 further promotes a number of articles to be collected and separated from newly arriving articles, thereby improving the loading and power efficiency of the heating device. Slowing the containers allows them be delivered continuously, at a substantially predetermined pitch (timing between successive container deliveries) to the belt 150.

As with the previously described staging embodiment, the containers C, are oriented with their openings facing forward and a deposited article will maintain a position in the lateral center of the belt 150 as it approaches the belt forming means 160. The belt 150 with the intermittently-disposed, untreated containers then passes through the belt forming means 160 to curl the belt in its lateral dimension into a curled belt at point 159, with the untreated containers C disposed thereon. After passing through the entrance choke 111, the untreated containers are passed through the exposure chamber 102 and exposed to the microwave energy as previously described herein.

In yet another alternative embodiment of a staging system, the stream of untreated containers C can be accumulated into a storage and queuing area, and then fed individually onto the belt and into and through the microwave heater. An example of a storage and queuing area and apparatus is a container cup nesting and de-nesting assembly. Untreated beverage containers are received in one or more stacks, and an end-most container is removed from the stack (de-nested) at a predetermined pitch (interval and rate). The de-nested beverage container is then deposited at and onto the in-feed end of the conveyor belt. Examples of an apparatus for de-nesting a stack of container cups are illustrated and described in U.S. Pat. Nos. 2,556,740, 3,756,452 and 6,913,433, and EP Patent 2,025,629, the disclosures of which are incorporated by reference in their entireties.

A non-limiting example of an article to be treated in the industrial microwave heating device of the invention is a paperboard beverage container, comprising a microwave-activatable material (and specifically, a microwave-expandable insulative foam material). The paperboard beverage container includes an upper rim that defines the top opening of the container, and a sidewall comprising a layer or lines of the microwave-expandable insulative foam material. A non-limiting example of such a paperboard beverage container is described in US Publication 2013/0303351, US Publication 2007/0228134, US Publication 2009/0321508, US Publication 2012/0285972, US Publication 2014/0103103 and U.S. Pat. No. 8,529,723, the disclosures of which are incorporated by reference in its entireties. The component elements of a beverage container (also called herein a cup) include a sidewall substrate onto which is applied a layer, or a plurality of lines, of a microwave-expandable foam insulating material, which will serve upon activation as an adhesive between the sidewall substrate and a second substrate to form a double-wall cup. The sidewall substrates and the container bottoms are formed into a structurally-assembled though untreated container cups.

Control of Oven Power and Product Pitch

The activation of a microwave-activatable material generally requires that the material absorb a specific amount of microwave energy (E) for complete (100%) activation. For a single article, the amount of microwave energy that the article is required to absorb for full activation (Eo) is proportional to the mass quantity of the microwave-activatable material in the article. Assuming that the article moves at a constant speed through the path of the exposure chamber of a predetermined, finite distance, each article remains within the exposure chamber for a predetermined time (To, seconds). For a single article passing through the exposure chamber, the power requirements (Wo) are the energy absorbed (Eo) divided by the time of exposure (To). In order to maintain production rate and to stabilize the power consumption at any instant, the spacing between consecutive articles is set to ensure that a fixed number of articles (Ntotal) are within the exposure chamber at any one time, and can be, for example, from 10-30 articles. Consequently, the total power requirements of the oven at typical production rates is Wo×Ntotal, or Wtotal.

Complete and uniform activation of the quantity of microwave-activatable material in the article can be determined by measuring the external temperature of the article upon exiting the exposure chamber. For a particular article type (for example, a paperboard beverage cup with double-walled sidewalls with a layer of activatable material applied therebetween), a complete activation of the microwave-activatable material in the cup will result in a substantially constant external temperature at the outside surface of the cup within a temperature range (Trange). Excessive absorption of microwave energy by a portion of the microwave-activatable material will result in temperatures above Trange, and insufficient absorption of microwave energy by the portion of the microwave-activatable material will result in temperatures below Trange.

In a further aspect of the invention, a control system can be provided that includes a system for capturing and recording the time of each article unit entering and/or exiting the exposure chamber. FIG. 6 shows a photo eye system mounted at the exit end 105 of the exposure chamber, including a light emitter 92 emitting infrared light beam 91 and a light detector 93 for detecting the emission of the light beam 91. The detection of the emission of the light beam is interrupted as each treated container Ct passes through the pathway of the beam 91. A counter device 94 receives the signal received by the light detector 93 and communicates the treated article pitch information to a controller 98. A similar photo eye system can be installed at the entrance of the exposure chamber to detect and communicate the untreated article pitch information to the controller. Using article pitch information, belt speed, and exposure chamber length, the controller can determine the number of articles residing within the exposure chamber at any moment.

The control system can also include thermal detectors for measuring the temperature of the one or more portions of the outside surface of the treated article as they exit the exposure chamber 102.

FIG. 6 also shows a pair of thermal detectors 96 and 97 trained at a side and at a top surface, respectively, of a treated article Ct. The thermal detectors measure the temperature of the surface at which the thermal detector is directed. When directed on a surface of the treated container, the temperature at that surface is detected and communicated to the controller 98. The timing for the detecting of temperatures can be controlled using the photo eye system described above. Typically, the thermal detector will take two or more temperature readings along each of a side and the top of a treated container, and a control reading between treated containers, which typical measures the temperature of the belt 150. The controller can compare the detected temperatures against the predicted temperature range for complete activation, and can make adjustments to the microwave power generator 8 and/or signal an alarm if the temperature is either above or below the target range (Trange). The control system comprises circuitry and processors to can make adjustments to the output of the microwave generator 8 in response to the measured temperatures of the treated containers Ct, or variations in wither the belt speed or article in-feed pitch, in order to provide the proper amount of microwave energy for complete activation of the articles.

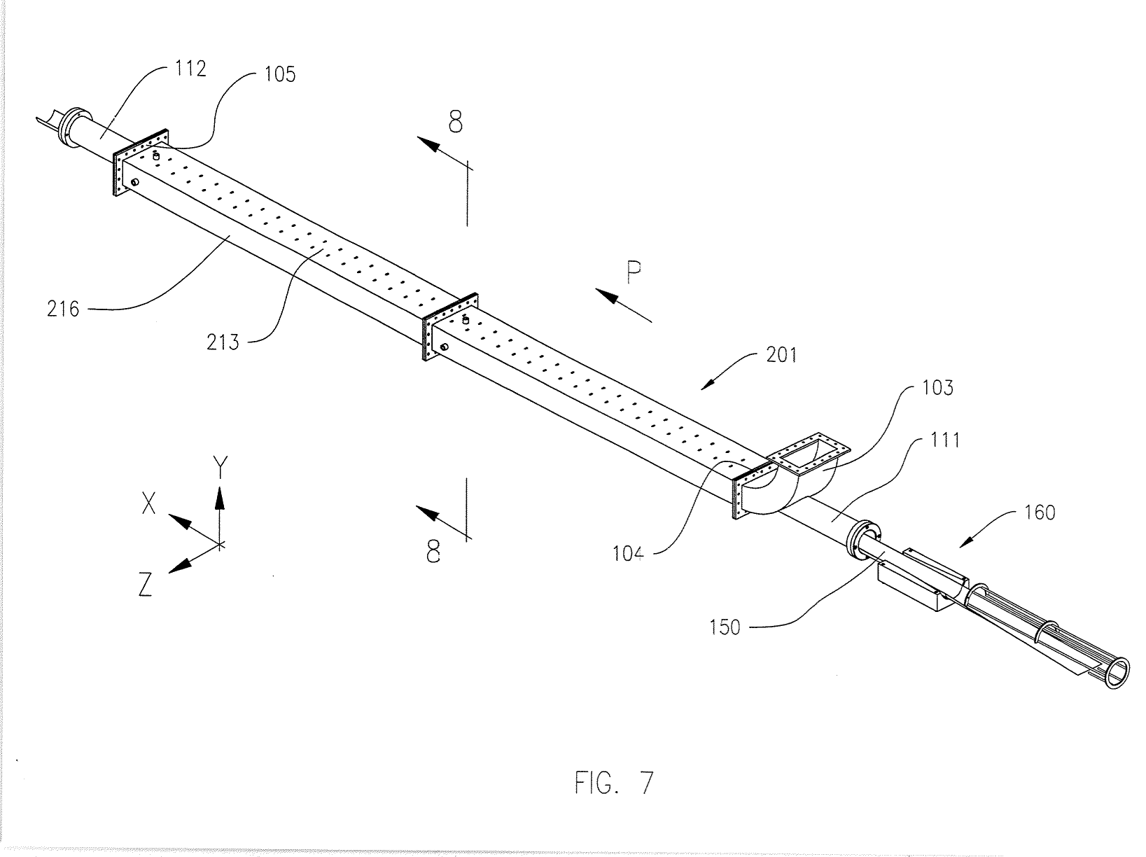

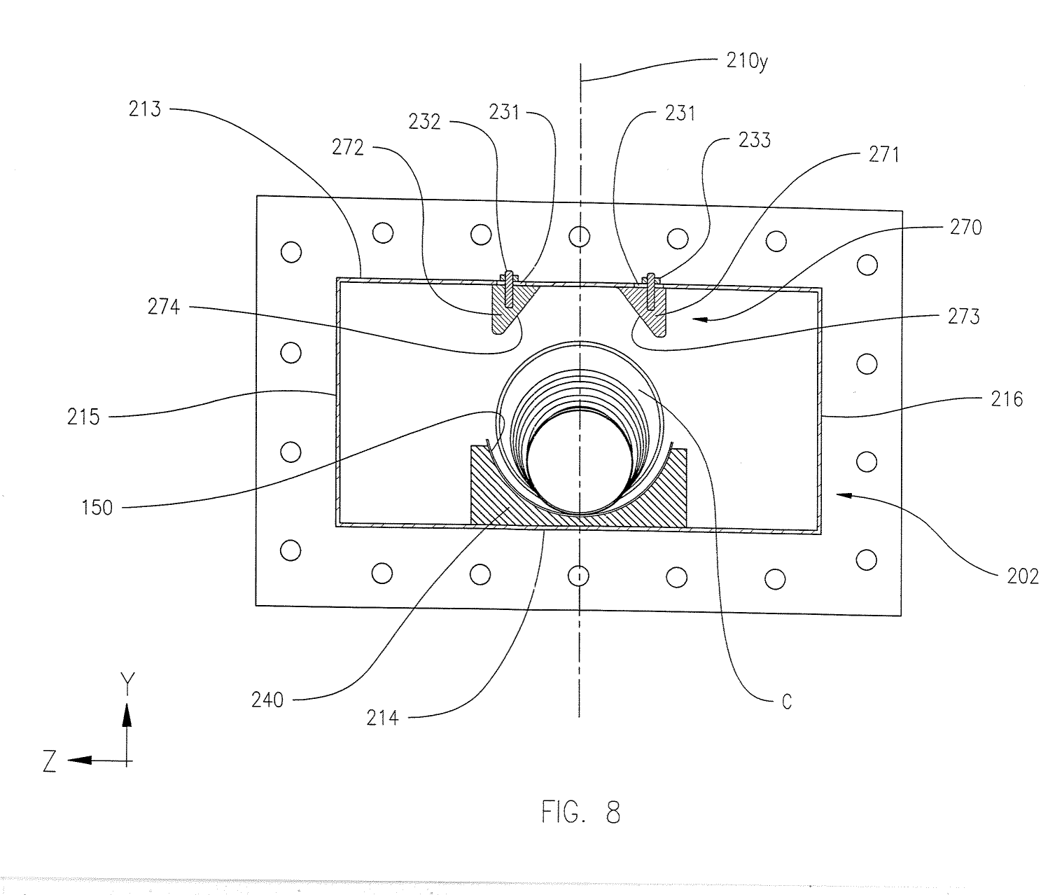

In an alternative embodiment of the invention, the waveguide can include a regular, linear rectangular waveguide 201, without using any twisting sections, shown in FIGS. 7 and 8. A linear exposure chamber can include one or more of a metallic ridge disposed within the waveguide for guiding or distorting the propagating microwaves into a pattern that improves the uniformity of exposure of the conveyed article(s) to the microwaves. FIG. 8 is a lateral sectional view through the rectangular exposure chamber 202, showing a pair of metallic ridges 271, 272 attached to the upper sidewall 213, on opposite sides of the lateral centerline 210y. The pair of metallic ridges 271, 272 are positioned between the centerline 210y and the respective sidewalls 215, 216, and are shaped to deflect heating electromagnetic energy toward or away from the center portion of the exposure chamber, to enhance and to normalize heating in the transverse central portion of the exposure chamber, and along the conveying belt. The ridges also act to decrease the cut off wavelength for a particular operating frequency thus allowing the width of the waveguide to be reduced to less than half a wavelength if required. The ridges are typically placed continuous along the entire length of the exposure chamber to aid uniform heating along the entire length of the exposure chamber.

In an aspect of the invention, the pair of metallic ridges is formed as mirror images so as to create a symmetrical distribution of waves on each lateral side portion of the exposure chamber from the lateral centerline. The metallic ridge can have a base surface and a main angular surface extending from an edge of the base surface. The pair of metallic ridges are illustrated with the main angular surfaces 273, 274 facing toward the centerline 209 of the exposure chamber. The size and shape of the metallic ridges 270, or their lateral positioning from the centerline 210y, may be varied advantageously to customize the electric field profile of the waves to accommodate a variety of container cup sizes and shapes, and for the type and pattern of the microwave-activatable coating or adhesive. A means for adjusting the positions of the metallic ridges from the center line 210y can be provided, which can include a laterally-extending slot 231 in the waveguide top wall 213, and a threaded bolt 232 extending from the base surface of the metallic ridge 270, and secured with a threaded nut 233.

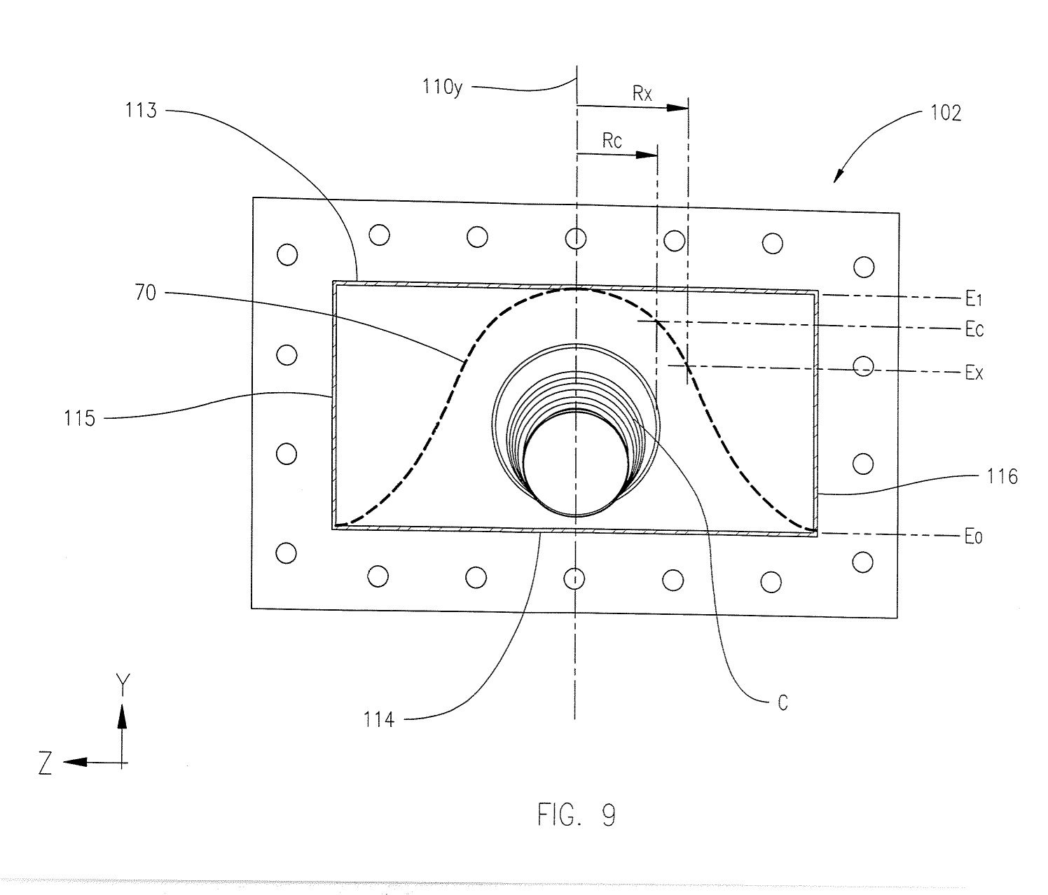

FIG. 9 shows the electric field pattern for the fundamental TE10 mode, the microwave frequency, boundary conditions and aspect ratio ensure a sinusoidal electrical field distribution in the transverse section of the waveguide along the rectangular waveguide 101. Energy curve 70 illustrates the predicted magnitude of energy across the width of the exposure chamber 102 between the opposed sidewalls 115 and 116. The magnitude of energy Ex at any radius distance Rc is determined by the energy curve 70. As shown, the magnitude at the centerline 110y is E1, while the magnitude at the sidewalls 115, 116 is zero (E0). The energy curve 70 illustrates that the magnitude of energy drops from E1 to E0 with the distance R from the centerline 110y toward the sidewalls 115, 116. At the distance (RC) of the lateral-most edge of the container C, the energy magnitude (EC) is somewhat less than E1 at the centerline 110y.

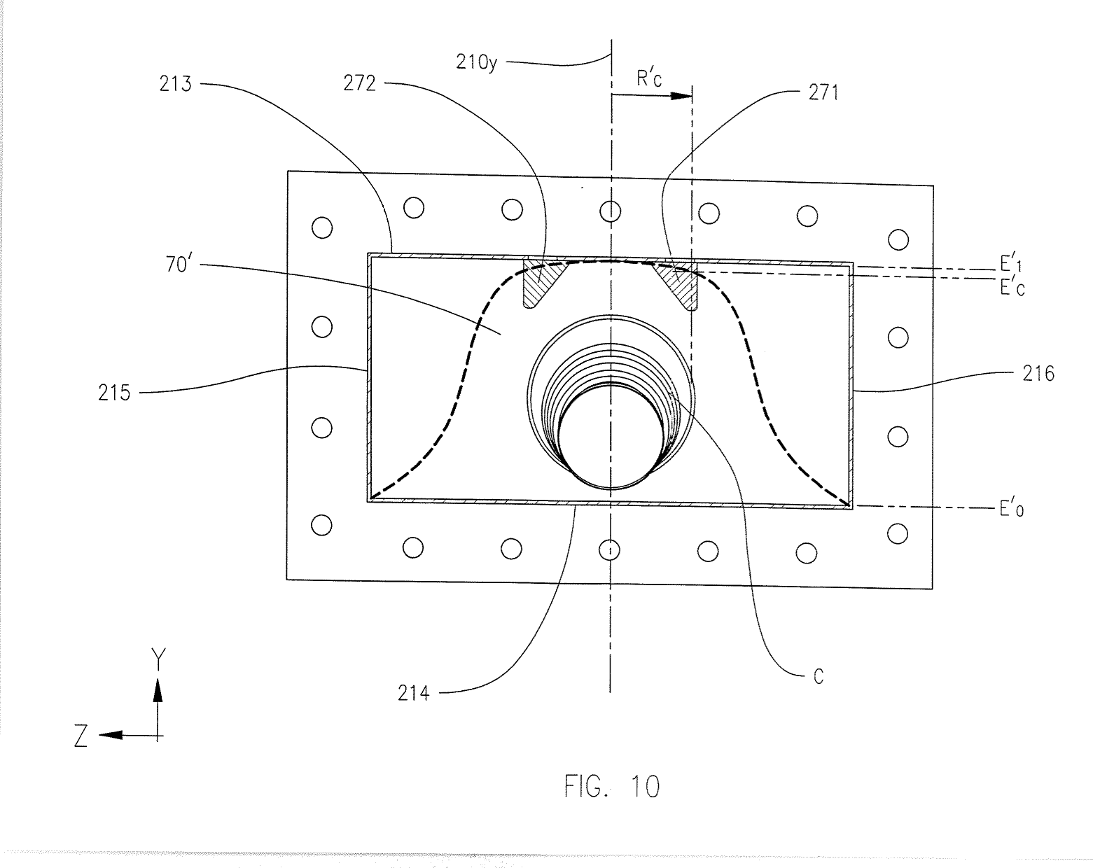

FIG. 10 illustrates the effect on the energy pattern through the waveguide resulting from the placement of metallic ridges with the waveguide. The metal ridges 271 and 272 in FIG. 10 modify the typical TE10 electric field pattern in the transverse section of the waveguide, subject to the ridge design and placement. The magnitude of the electric field in the region below the ridge is increased, causing the typical sinusoidal electric field pattern 70 (shown in FIG. 9) to be modified to a more flattened electric field pattern 70′, which provides a more even energy field distribution across the portion of the waveguide through which the container C passes. Consequently, at the distance (R′C) of the lateral-most edge of the container C, the energy magnitude (E′C) using the metallic ridges is substantially higher than the magnitude (EC) of the standard exposure chamber, which substantially improves the uniformity of the heating of the activatable material within the container C.

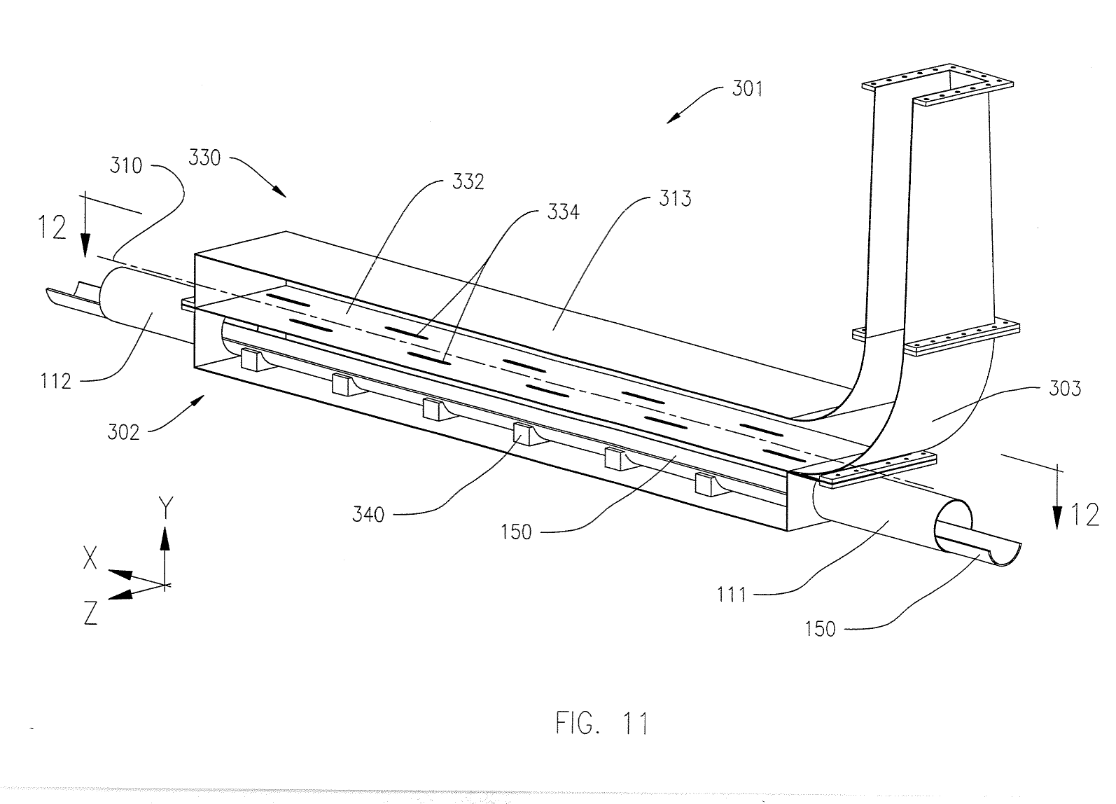

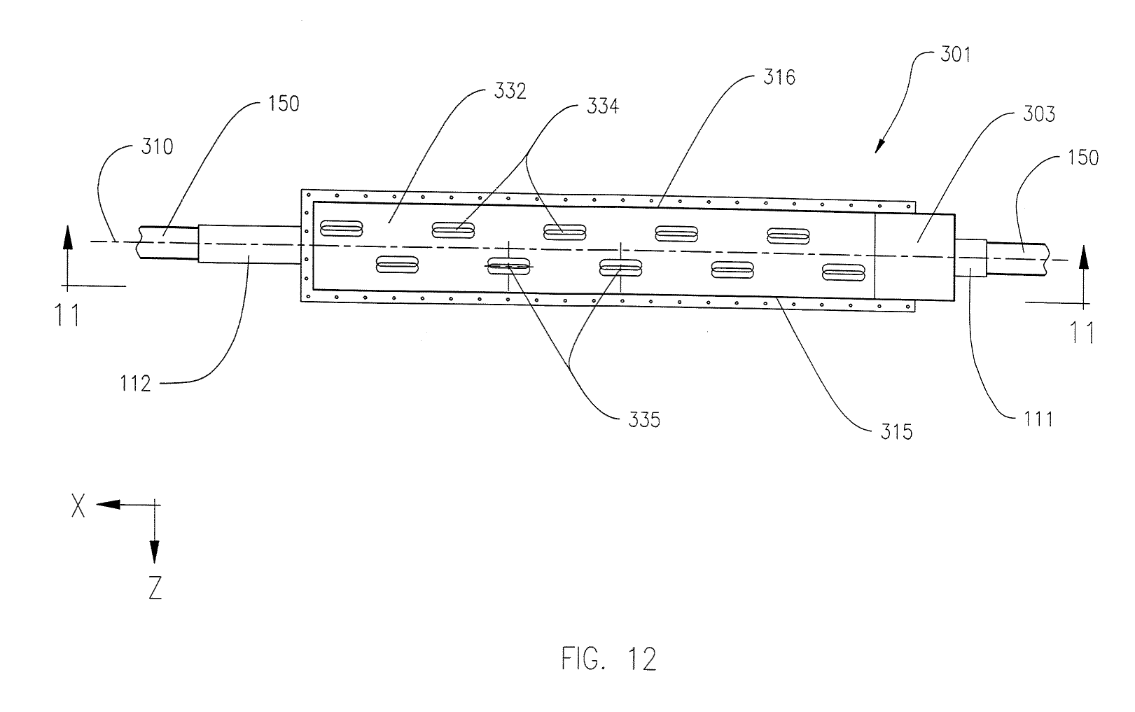

In a further aspect of the invention, a waveguide 301 having sidewalls 315, 316 and upper wall 313, and inlet 303, can comprise an upper waveguide chamber having a rectangular cross section through which the microwaves are propagated, and an exposure chamber 302, as shown in FIGS. 11 and 12. The upper waveguide chamber 330 and the exposure chamber 302 are separated by an elongated plate 332 having a plurality of longitudinally-formed slots 334 therethrough, for passing microwave energy from the upper waveguide chamber 330 to the exposure chamber 302. The slots 334 can be spaced along both sides of the centerline 310 in a staggered arrangement, with the spacing between the centerlines 335 of the slots 334 being a distance of about one-half a waveguide wavelength (λ) of the electromagnetic wave supplied by the microwave source. The spacing distance is about 6.45 inches for microwaves of 915 MHz, and about 2.45 inches for microwaves of 2.45 GHz. The row of slots 334 are spaced about one-third the distance from the centerline 339 to the respective sidewall 315, 316. Examples of microwave heating devices having an array of slots communicating through a wall of the waveguide are disclosed in U.S. Pat. Nos. 4,160,145 and 5,369,250, the disclosures of which are incorporated by reference in their entireties.

Although the invention has been disclosed in detail with reference to a few preferred versions, other versions are possible. The side wall passageways, blocks, corner blocks, dormers, and ridges may be used with each other in various combinations, symmetrical or asymmetrical, to achieve a desired heating pattern. They may reside in the bend segments of the waveguide as well as in the straight segments as depicted in the drawings. The heating chambers may be terminated in short circuits to produce standing wave patterns or in matched impedances to avoid standing waves and hot spots along the length of the heating chamber. Although the preferred frequency of operation is one of the standard commercial frequencies (896, 915, 922 MHz or 2450 MHz), the waveguide structures may be dimensioned to work at other frequencies. So, as these few examples suggest, the scope of the claims is not meant to be limited to the details of the versions described.

We claim:

1. A microwave heating device comprising:
(a) a waveguide that includes a bend segment and a plurality of twisted rectangular waveguide sections that define an exposure chamber, the waveguide exposure chamber having a first end and a second end, said plurality of twisted rectangular sections for rotating a perpendicular microwave field pattern along a length of the waveguide;
(b) a source of microwave energy for generating microwaves that propagate through the waveguide along the exposure chamber in a propagation direction;
(c) a first port attached to said waveguide and in communication with the exposure chamber at the first end, and a second port attached to the exposure chamber at the second end and in communication with the exposure chamber; and
(d) a conveyancing means for conveying an article that is to be microwave heated within said waveguide, said conveyancing means passing through the exposure chamber along a conveying path, the conveyancing means entering through one of the first and second ports and exiting out the other of the first and second ports.

2. The heating device according to claim 1, wherein the conveyancing means enters said first port and exists said second port and said microwave propagation is in the same direction as said conveying path.

3. The heating device according to claim 1, wherein the conveyancing means is a conveyor belt system comprised of a pair of drive pulleys and a flexible belt extending therebetween, said belt driven by said pulleys in a drive direction.

4. The heating device according to claim 3, further including a means for forming and maintaining the belt into a curled shape in cross section as the belt passes through the exposure chamber, a first of said means associated with said first port and a second one of said means associated with said second port.

5. The heating device according to claim 4, further including a plurality of identical belt supports disposed intermittently along the exposure chamber, each support including a support surface to support the curled belt, the support surface having an arcuate shape in cross section.

6. The heating device according to claim 4, wherein the means for forming the belt into a curled shape in cross section comprises a forming block having a trough, the surface of the trough having an inlet end and an outlet end, wherein the outlet end of the trough has a tapering, arcuate shape in cross section.

7. The heating device according to claim 6, wherein the inlet end of the trough has an arcuate shape in cross section, the arcuate shape at the inlet end having a radius of curvature that is larger than a radius of curvature of the arcuate shape of the outlet end.

8. The heating device according to claim 7, wherein the arcuate shape at the outlet end of the trough has a circular arc of at least 120°.

9. The heating device according to claim 3, wherein the belt of the conveyancing system is selected from the group consisting of a fiberglass coated belt, a plastic link belt and a polymer belt.

10. The heating device according to claim 9, wherein the flexible belt is a microwave transmissive plastic link belt and the drive pulleys include sprockets that mesh with cutouts within the links that form said plastic link belt.

11. The heating device according to claim 9, wherein the flexible belt is a polymer selected from the group consisting of an ultra-high molecular weight polyethylene (UHMWPE) and a polypropylene.

12. The heating device according to claim 9, wherein the flexible belt is a fiberglass belt coated with polysulfone or polypropylene.

13. The heating device according to claim 10, wherein the plastic link belt includes lateral side support panels.

14. The heating device according to claim 1, further including a staging system that de-accelerates the speed of an article prior to a said article being deposited onto said conveyance means and into said waveguide, said staging system further positioning a conveyed article onto a lateral centerpoint of said conveying means.

15. The heating device according to claim 14, wherein the staging system is one of a permanent and removable component.

16. The heating device according to claim 15, wherein the staging system is permanently attached to and made a part of said waveguide and is comprised of a set of open guiderails associated with a first end of said conveyancing means and a set of spaced side rails associated with said guiderails, said guiderails for directing and de-accelerating an article onto said conveying means, said side rails for further de-accelerating said article and positioning said article for entry into said first port, each of said side rails comprised of an identical set of rotating belts.

17. The heating device according to claim 15, wherein the staging system is transportable such that said staging system is moved into close association with said entrance port of said waveguide, said transportable staging system comprising a movable frame, a pair of identical arms attached to said frame, each of said arms having a respective and identical belt drive system attached thereto for de-accelerating and positioning an article onto said conveyancing means.

18. The heating device according to claim 17, wherein said drive system is driven by a common drive motor, said drive belt system comprised of a de-acceleration belt extending along a length of said arm that rotates around a pair of displaced pulleys

19. The heating device according to claim 1, including two or more entrance ports, two or more outlet ports, a corresponding two or more flexible belts, and a corresponding two or more means for forming the two or more belts into a curled shape in cross section.

20. The heating device according to claim 1, further including a means for forming and maintaining the belt into a curled shape in cross section as the belt passes through the exposure chamber.

21. The heating device according to claim 20, wherein plurality of slots are spaced in a line along both sides of longitudinal centerline in a staggered arrangement.

22. The heating device according to claim 21, wherein the spacing between a centerlines of a line of slots is a distance of about 6.45 inches for 915 MHz, or 2.5 inches for 2.45 GHz.

23. The heating device according to claim 20, further including one or more metallic ridges extending along the length of the exposure chamber for guiding or distorting the propagating microwave field into a modified pattern that improves the uniformity of microwave energy across the exposure chamber, wherein the pair of metallic ridges are formed as mirror images, each metallic ridge having a main angular surface and disposed with the main angular surface facing the centerline.

24. The heating device according to claim 23, wherein one or more metallic ridges includes a pair of opposed, mirror image ridges disposed on opposite sides of a centerline of the exposure chamber.

25. The heating device according to claim 24, further including a means for adjusting the positions of the metallic ridges from the centerline.

26. A method for making an article comprising a microwave-activatable material in an industrial microwave heating device, comprising the steps of:
i) providing a plurality of untreated container cups comprising a microwave-activatable material, and including a upper rim that defines the top opening of the cup;
ii) delivering the untreated container cup to a continuous conveying belt having an upper surface;
iii) passing the belt and the untreated container cups disposed thereon into and through a waveguide of the industrial microwave heating device;
iv) propagating microwaves through the waveguide, to activate the microwave-activatable material with microwave energy, to form treated container cups;
v) passing the belt and the treated container cup out from the waveguide; and
vi) releasing the treated container cup from the conveying belt.

27. The method according to claim 26 further including the step of curling the conveying belt in the lateral dimension into a curled belt before passing the belt into the waveguide, and uncurling the belt after passing the belt out of the waveguide.

28. The method according to claim 27 wherein the microwave-activatable material is a coating or adhesive material.

29. The method according to claim 28 wherein the microwave-curable material is a microwave-expandable foam material.

30. The method according to claim 27 wherein waveguide of the industrial microwave heating device includes a plurality of twisted rectangular sections, for rotating a perpendicular microwave field pattern along the length of the waveguide.

31. The method according to claim 30 wherein the plurality of twisted rectangular sections includes an odd number of 90-degree twisted rectangular sections.

32. A method for controlling the microwave activation of a microwave-activatable material comprised in an article in an industrial microwave heating device that includes a microwave energy source and an exposure chamber, comprising the steps of: i) determining the number of articles comprising the microwave-activatable material disposed within the exposure chamber of the heating device over a period of time; ii) measuring the temperature of one or more surfaces of a treated article exiting the heating device during the period of time; iii) comparing the measured temperature against a target temperature for a treated article having proper activation of the microwave-activatable material; and iv) controlling the energy output of the microwave energy source as a function of the comparison of the measured temperature and the target temperature, and of the number of articles disposed within the exposure chamber.
